(19) United States
(12) Patent Application Publication
(10) Pub. No.: US 2025/0102763 A1
(43) Pub. Date: Mar. 27, 2025

(54) OPTICAL ELEMENT DRIVING MECHANISM

(71) Applicant: TDK TAIWAN CORP., Taoyuan City (TW)

(72) Inventors: Wei-Jhe SHEN, Taoyuan City (TW); Po-Xiang ZHUANG, Taoyuan City (TW); Yi-Ho CHEN, Taoyuan City (TW); Sin-Jhong SONG, Taoyuan City (TW)

(21) Appl. No.: 18/895,909

(22) Filed: Sep. 25, 2024

Related U.S. Application Data
(60) Provisional application No. 63/584,983, filed on Sep. 25, 2023.

(51) Int. Cl. G02B 7/09; G02B 5/00; G02B 27/64

(52) U.S. Cl. CPC G02B 7/09; G02B 5/005; G02B 27/64

(57) ABSTRACT

An optical element driving mechanism is provided. The optical element driving mechanism includes a movable part, a fixed part, and a driving assembly. The movable part is for connecting an optical element. The movable part moves relative to the fixed part. The driving assembly is for driving the movable part to move.

### CROSS REFERENCE TO RELATED APPLICATIONS

This application claims the benefit of U.S. Provisional Application No. 63/584,983, filed 2023 Sep. 25, the entirety of which is incorporated by reference herein.

### BACKGROUND OF THE INVENTION

### Field of the Invention

The present invention relates to an optical element driving mechanism, and, in particular, to an optical element driving mechanism with a movable part and a plurality of connecting elements.

### Description of the Related Art

With the development of technology, many electronic devices today (such as computers and tablets) have the function of taking photos and recording videos. The use of these electronic devices is becoming increasingly common, and while they have been developed to be more stable and have better optical quality, the design trend is also moving towards making them more convenient with a slim profile, to provide users with more options.

However, when it is necessary to install optical elements with longer focal lengths (such as lenses) into the aforementioned electronic devices, it results in an increase in the thickness of the electronic device, which is not advantageous to the slimming and stability of the electronic device. In view of this, designing an optical system that allows electronic devices to be slim and stable has become an important issue.

### BRIEF SUMMARY OF THE INVENTION

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to certain aspects of the present disclosure, an optical element driving mechanism is provided. The optical element driving mechanism includes a movable part, a fixed part, and a driving assembly. The movable part is for connecting an optical element. The movable part moves relative to the fixed part. The driving assembly is for driving the movable part to move.

According to certain aspects of the present disclosure, the optical element driving mechanism further includes an aperture assembly. The aperture assembly has a plurality of blades, wherein the plurality of blades form an opening through which incident light enters the optical element. The fixed part includes an outer cover and a buffering element. The outer cover at least partially covering the aperture assembly and the optical element. The buffering element is disposed between the outer cover and the aperture assembly.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1 is a perspective view of the optical element driving mechanism, according to certain aspects of the present disclosure.

FIG. 2 is a cross-sectional view of the optical element driving mechanism and the optical element along line A-A of FIG. 1, according to certain aspects of the present disclosure.

FIG. 3 is a perspective view of the optical element driving mechanism and the optical element, with the outer cover and buffering element removed for illustrative purposes, according to certain aspects of the present disclosure.

FIG. 4 is an exploded perspective view of the optical element driving mechanism and the optical element, with the outer cover and buffering element removed for illustrative purposes, according to certain aspects of the present disclosure.

FIG. 5 is a cross-sectional view of the optical element driving mechanism and the optical element along line B-B of FIG. 1, with the outer cover and buffering element removed, and the first part of the base is shown with dashed lines for illustrative purposes, according to certain aspects of the present disclosure.

FIG. 6 is a top view of the optical element driving mechanism and the optical element with the blades of the aperture assembly in a first position, with the outer cover, inner cover, and buffering element removed for illustrative purposes, according to certain aspects of the present disclosure.

FIG. 7 is a top view of the optical element driving mechanism and the optical element with the blades in a second position, with the outer cover, inner cover, and buffering element removed for illustrative purposes, according to certain aspects of the present disclosure.

FIG. 8 is a top view of the optical element driving mechanism and the optical element with the blades in a third position, with the outer cover, inner cover, and buffering element removed for illustrative purposes, according to certain aspects of the present disclosure.

FIG. 9 is a top view of the optical element driving mechanism and the optical element with the blades in a fourth position, with the outer cover, inner cover, and buffering element removed for illustrative purposes, according to certain aspects of the present disclosure.

### DETAILED DESCRIPTION OF THE INVENTION

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended patent application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

This disclosure relates to an optical element driving mechanism, having a driving assembly and a guiding assembly, which drive the movable part and an optical element to move, thereby adjusting the imaging of the optical element driving mechanism to meet different photographic needs.

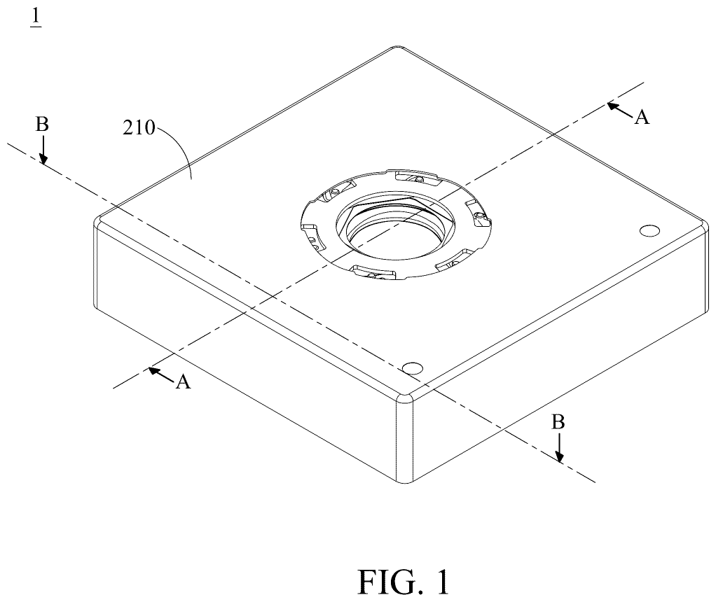

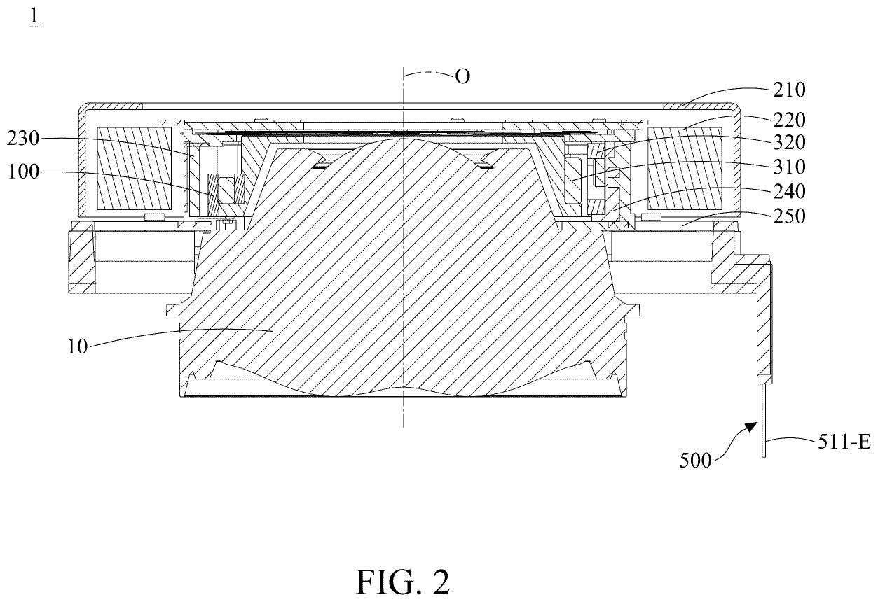

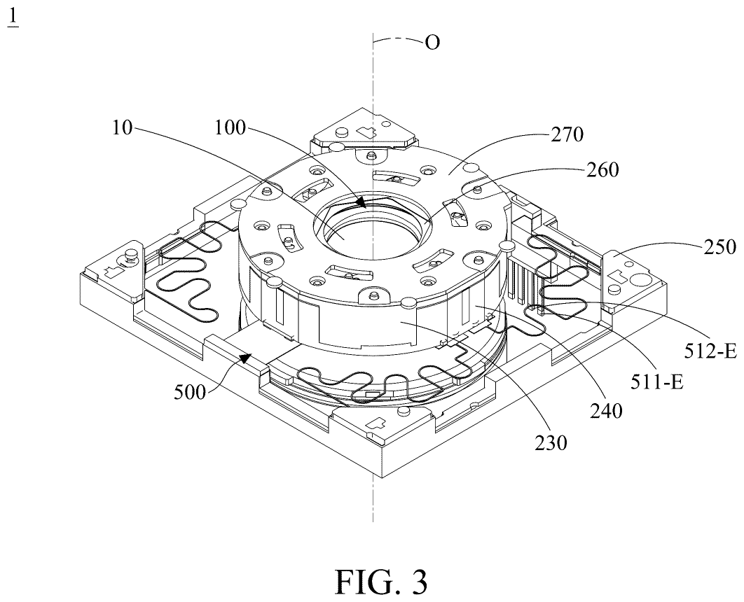

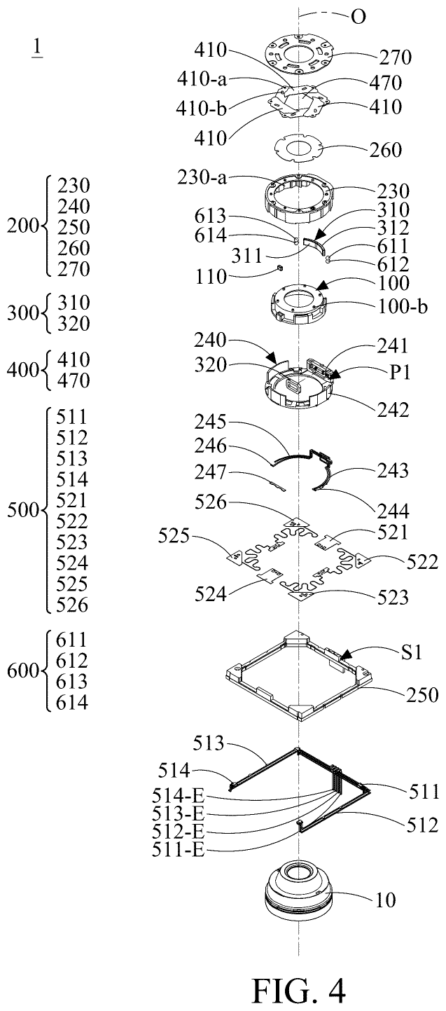

First, please refer to FIG. 1 to FIG. 4. FIG. 1 is a perspective view of the optical element driving mechanism 1, according to certain aspects of the present disclosure. FIG. 2 is a cross-sectional view of the optical element driving mechanism 1 and the optical element 10 along line A-A of FIG. 1, according to certain aspects of the present disclosure. FIG. 3 is a perspective view of the optical element driving mechanism 1 and the optical element 10, with the outer cover 210 and the buffering element 220 removed for illustrative purposes, according to certain aspects of the present disclosure. FIG. 4 is an exploded perspective view of the optical element driving mechanism 1 and the optical element 10, with the outer cover 210 and the buffering element 220 removed for illustrative purposes, according to certain aspects of the present disclosure.

The optical element driving mechanism 1 includes a movable part 100, a fixed part 200, a driving assembly 300, an aperture assembly 400, a circuit assembly 500, and a guiding assembly 600. The movable part 100 connects the optical element 10, which may be, for example, an optical lens. The movable part 100 may move relative to the fixed part 200. The driving assembly 300 drives the movement of the movable part 100. The optical element 10 is disposed on a lens driving device (not shown), and achieves the functions of automatic focusing (AF) and optical image stabilization (OIS) through the lens driving device, and the lens driving device has a plurality of driving circuit parts (not shown in figures), for driving the lens driving device.

The movable part 100 includes a stabilizing element 110. The stabilizing element 110 is fixedly disposed on the movable part 100 on the side that is opposite the magnetic element 310 of the driving assembly 300. The stabilizing element 110 may be a magnetic element with a different size from the magnetic element 310, providing additional magnetic attraction to stabilize the structure of the movable part 100.

The fixed part 200 includes an outer cover 210, a buffering element 220, a frame 230, a base 240, a bottom 250, a light-blocking element 260, and an inner cover 270.

The outer cover 210 at least partially covers the aperture assembly 400 and the optical element 10. The buffering element 220 is disposed between the outer cover 210 and the aperture assembly 400. The outer cover 210 and the buffering element 220 protect the elements inside the optical element driving mechanism 1 from external impacts.

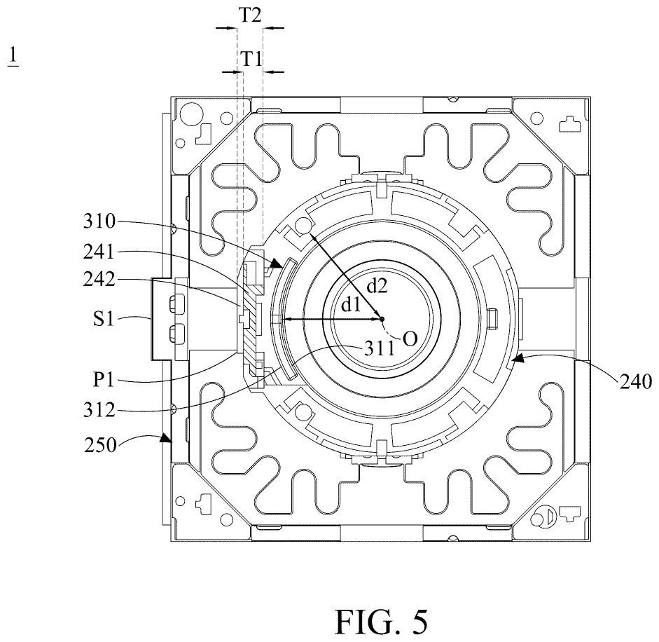

Please also refer to FIG. 5. FIG. 5 is a cross-sectional view of the optical element driving mechanism 1 and the optical element 10 along line B-B of FIG. 1, with the outer cover 210 and the buffering element 220 removed, and the first part 241 of the base 240 is shown with dashed lines for illustrative purposes, according to certain aspects of the present disclosure. The frame 230 is fixedly connected to the base 240. The base 240 has a protruding structure P1. The protruding structure P1 protrudes towards the first side S1 of the bottom 250.

The base 240 includes a first part 241, a second part 242, and a plurality of connecting elements 243, 244, 245, 246, 247. The second part 242 is fixedly connected to the first part 241. The thickness T2 of the second part 242 is greater than the thickness T1 of the first part 241, and the hardness of the second part 242 is greater than the hardness of the first part 241. The plurality of connecting elements 243, 244, 245, 246, 247 are embedded within the second part 242.

The light-blocking element 260 may be made of light-absorbing material, such as SOMA. The inner cover 270 is movably disposed on the aperture assembly 400. The aperture assembly 400 is located between the light-blocking element 260 and the inner cover 270.

Next, please continue to refer to FIG. 4. The driving assembly 300 includes a magnetic element 310 and a coil 320. The magnetic element 310 is disposed on the movable part 100. The coil 320 is disposed on the protruding structure P1 of the base 240, adjacent to the first side S1.

Through the electromagnetic driving force generated between the magnetic element 310 and the coil 320, the magnetic element 310 moves relative to the coil 320. Thus, the movable part 100 moves relative to the base 240 and the movable part 100 drives the movement of the aperture assembly 400. Therefore, the electromagnetic driving force generated between the magnetic element 310 and the coil 320 may drive the movable part 100 to move the aperture assembly 400 relative to the base 240.

The aperture assembly 400 has a plurality of blades 410. In this embodiment, there are six blades 410. The six blades 410 form an opening 470 through which incident light passes to reach the optical element 10.

The circuit assembly 500 includes a plurality of external elements 511, 512, 513, 514, and a plurality of elastic elements 521, 522, 523, 524, 525, 526. The elastic elements 521, 522, 523, 524, 525, 526 are flexible. The external elements 511, 512, 513, 514 are electrically connected to the elastic elements 521, 522, 523, 524, 525, 526. The elastic elements 521, 522, 523, 524, 525, 526 are electrically connected to the coil 320 via the connecting elements 243, 244, 245, 246, 247.

The external elements 511, 512, 513, and 514 include a plurality of electrical connection parts 511-E, 512-E, 513-E, and 514-E extending along the direction of incident light. Which means that the electrical connection parts extend along the optical axis O. Specifically, the distance between the plurality of electrical connection parts 511-E, 512-E, 513-E, 514-E and the optical axis O is greater than the distance between the bottom 250 and the optical axis O. When viewed along the direction of incident light, the electrical connection parts 511-E, 512-E, 513-E, 514-E of the circuit assembly 500 at least partially overlap with the bottom 250 (see FIG. 1). Whereby, it is advantageous for disposing the optical element driving mechanism 1 on the lens driving device. Specifically, in this embodiment, there is no need to design additional circuits for driving the movable part 100 and the aperture assembly 400 in the lens driving device equipped with the optical element 10, which would complicate the structural design of the lens driving device. At the same time, in conjunction with the electrical connection parts 511-E, 512-E, 513-E, and 514-E of the circuit assembly 500 of the optical element driving mechanism 1 located on the first side S1, the driving circuit part of the lens driving device may also be disposed on the first side S1. When the electrical connection parts 511-E, 512-E, 513-E, 514-E and the driving circuit part are all disposed on the same side, the circuit design for controlling the optical element driving mechanism 1 and the lens driving device may be more convenient and simplified.

The base 240 is connected to the bottom 250 via the elastic elements 521, 522, 523, 524, 525, 526. Due to the flexibility of the elastic elements 521, 522, 523, 524, 525, 526, the base 240 may move relative to the bottom 250. The external elements 511, 512, 513, 514 are located on the first side S1 of the bottom 250.

The guiding assembly 600 includes a plurality of guiding elements. In this embodiment, there are four guiding elements 611, 612, 613, 614, disposed between the movable part 100 and the frame 230, adjacent to the first side S1. The movable part 100 is connected to the frame 230 via the four guiding elements 611, 612, 613, 614. The guiding elements 611, 612, 613, 614 movably connect the frame 230 and the movable part 100. When the movable part 100 is driven by the driving assembly 300 to move, the guiding elements 611, 612, 613, 614 roll between the frame 230 and the movable part 100, allowing the movable part 100 to move smoothly relative to the frame 230.

The magnetic element 310 includes a first surface 311 and a second surface 312. The first surface 311 and the second surface 312 face opposite directions. The first surface 311 faces the optical axis O, and the second surface 312 faces the coil 320. The distance d2 between the guiding elements 611, 612, 613, 614 and the optical axis O of the incident light is greater than the distance d1 between the magnetic element 310 and the optical axis O (please refer to FIG. 5). The distance d2 between the guiding elements 611, 612, 613, and 614 and the optical axis O of the incident light is greater than the distance d2 between the second surface 312 of the magnetic element 310 and the optical axis O. Both the first surface 311 and the second surface 312 are curved surfaces, and the radius of curvature of the first surface 311 is different from the radius of curvature of the second surface 312. The radius of curvature of the first surface 311 is smaller than the radius of curvature of the second surface 312. Therefore, when the electromagnetic driving force causes the element 310 to move relative to the coil 320, the electromagnetic driving force is more stable, thereby making the movement of the movable part 100 and the aperture assembly 400 more stable.

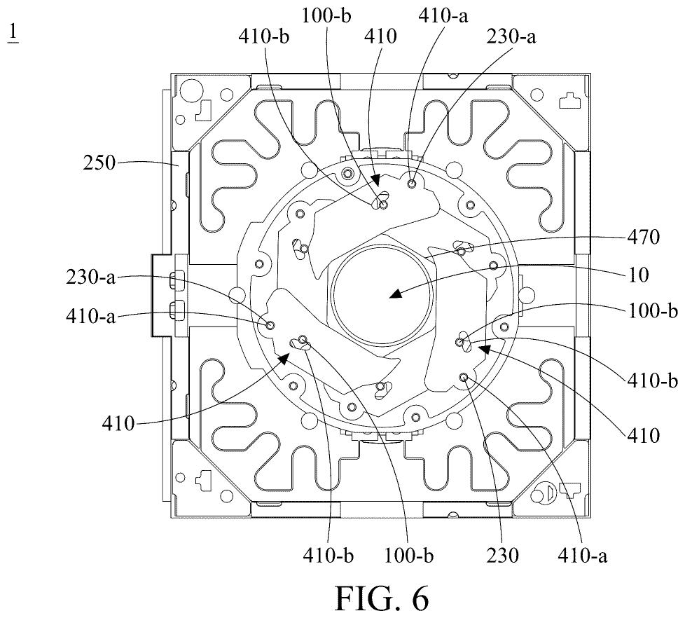

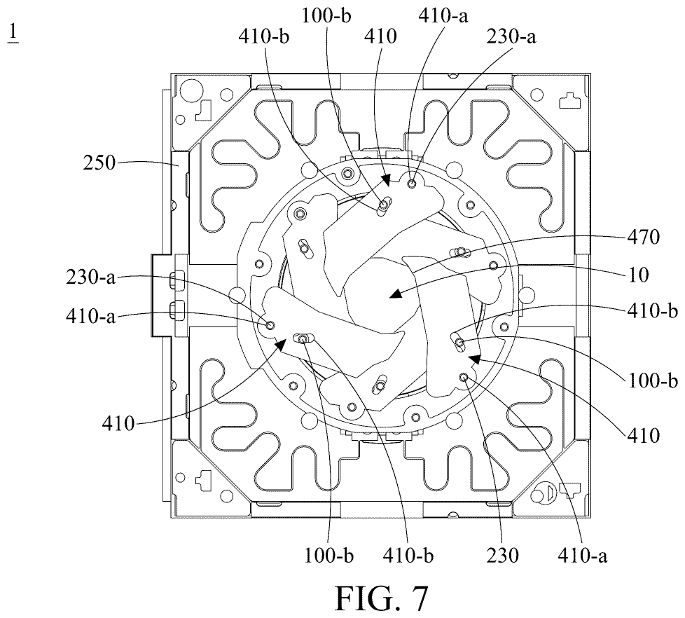

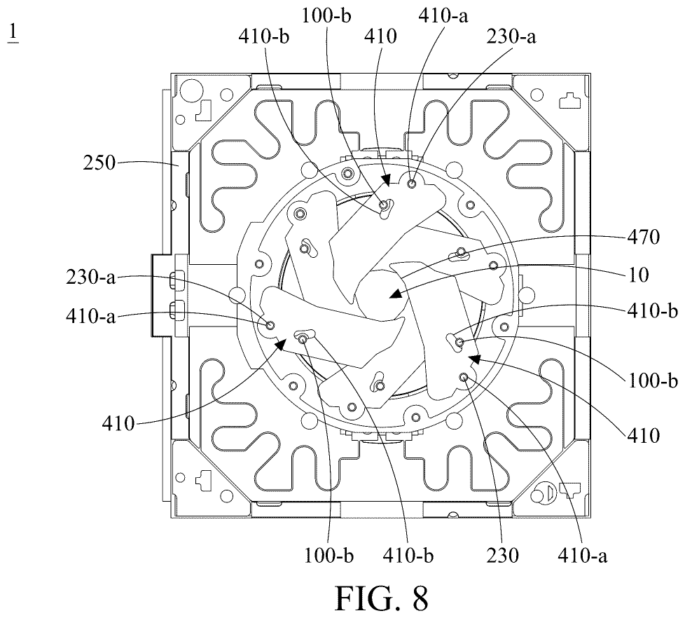

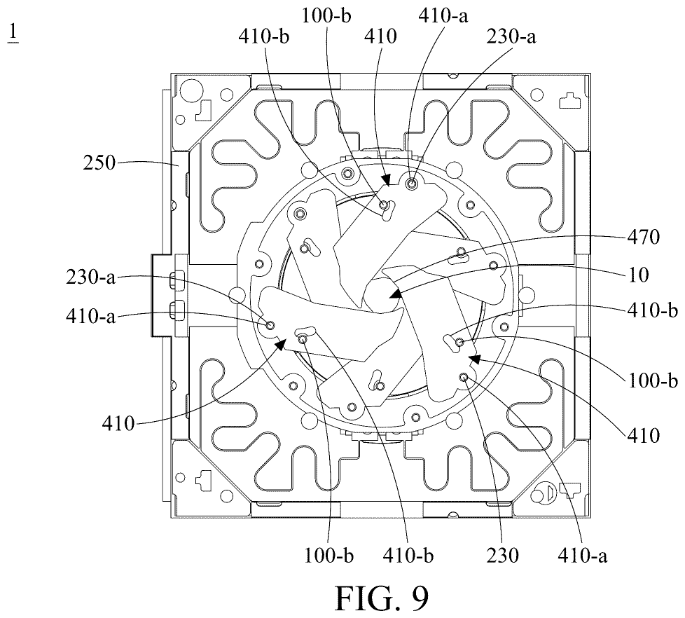

The movement of the movable part 100 relative to the frame 230 is described with reference to FIG. 6 to FIG. 9. FIG. 6 is a top view of the optical element driving mechanism 1 and the optical element 10 with the blades 410 in the first position, with the outer cover 210, the inner cover 270, and the buffering element 220 removed for illustrative purposes, according to certain aspects of the present disclosure. FIG. 7 is a top view of the optical element driving mechanism 1 and the optical element 10 with the blades 410 in a second position, with the outer cover 210, the inner cover 270, and the buffering element 220 removed for illustrative purposes, according to certain aspects of the present disclosure. FIG. 8 is a top view of the optical element driving mechanism 1 and the optical element 10 with the blades 410 in a third position, with the outer cover 210, the inner cover 270, and the buffering element 220 removed for illustrative purposes, according to certain aspects of the present disclosure. FIG. 9 is a top view of the optical element driving mechanism 1 and the optical element 10 with the blades 410 in a fourth position, with the outer cover 210, the inner cover 270, and the buffering element 220 removed for illustrative purposes, according to certain aspects of the present disclosure.

The movable part 100 connects the six blades 410. Each blade 410 has a hole 410-a and an elongated hole 410-b, for connecting the movable part 100 and the frame 230, as will be further explained below.

The movable part 100 and the blades 410 may move relative to the frame 230. The movable part 100 has a plurality of protrusions 100-b that pass through the elongated holes 410-b of the blades 410, allowing movements of the protrusions 100-b within the elongated holes 410-b.

The frame 230 has a plurality of protrusions 230-a that pass through the holes 410-a of the blades 410, allowing rotations of the protrusions 230-a within the holes 410-a. The blades 410 connect the movable part 100 to the frame 230 via the protrusions 100-b, and the protrusions 230-a, the elongated holes 410-b, and the holes 410-a.

When the movable part 100 is driven by the driving assembly 300 to move, the protrusions 100-b of the movable part 100 pass through the elongated holes 410-b of the blades 410 and move within the elongated holes 410-b. The protrusions 230-a of the frame 230 pass through the holes 410-a of the blades 410 and rotate within the holes 410-a, thereby driving the movement of the blades 410. By moving the blades 410, the size of the opening 470 formed by the blades 410 may be adjusted.

In the first position shown in FIG. 6, the opening 470 formed by the blades 410 is larger, allowing more incident light to pass through the opening 470 to reach the optical element 10.

In the second position shown in FIG. 7, the opening 470 formed by the blades 410 is smaller than the opening 470 formed in the first position shown in FIG. 6, allowing less incident light to pass through the opening 470 to reach the optical element 10, compared to the first position.

In the third position shown in FIG. 8, the opening 470 formed by the blades 410 is smaller than the opening 470 formed in the second position shown in FIG. 7, allowing less incident light to pass through the opening 470 to reach the optical element 10, compared to the second position.

In the fourth position shown in FIG. 9, the opening 470 formed by the blades 410 is smaller than the opening 470 formed in the first position shown in FIG. 6, the second position shown in FIG. 7, and the third position shown in FIG. 8. Thus, allowing less incident light to pass through the opening 470 to reach the optical element 10 compared to the first position, the second position, and the third position.

In summary, the present invention provides an optical element driving mechanism that includes a movable part, a fixed part, a driving assembly, an aperture assembly, and a guiding assembly. The movement of the driving assembly drives the movable part to move relative to the fixed part. This allows for the adjustment of the blades' positions and the amount of incident light reaching the optical element, adapting to different photographic needs and providing more stable optical quality. At the same time, through the design of the bottom and circuit assemblies, the optical element driving mechanism may be more easily disposed on the lens driving device, so that the structural design of the movable part of the optical element driving mechanism and the aperture assembly will not be affected by the lens driving device, and may be used with lens driving devices of different sizes. The circuit design for driving the movement of the movable part and aperture assembly and the circuit design of the lens driving device may be independent, simplifying the design of the control circuit.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments may be made, according to the disclosure herein, without departing from the spirit or scope of the invention. Thus, the breadth and scope of the present invention should not be limited by any of the above described embodiments. Rather, the scope of the invention should be defined, according to the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or claims are intended to be similar to “comprising” is included.

What is claimed is:

1. An optical element driving mechanism, comprising:
a movable part, for connecting an optical element;
a fixed part, wherein the movable part moves relative to the fixed part; and
a driving assembly, for driving the movable part to move.

2. The optical element driving mechanism as claimed in claim 1, further comprising:
an aperture assembly, having a plurality of blades, wherein the plurality of blades form an opening through which incident light enters the optical element.

3. The optical element driving mechanism as claimed in claim 2, wherein the fixed part includes:
an outer cover, at least partially covering the aperture assembly and the optical element; and
a buffering element, disposed between the outer cover and the aperture assembly.

4. The optical element driving mechanism as claimed in claim 3, further comprising a circuit assembly, wherein the circuit assembly includes:
a plurality of external elements; and
a plurality of elastic elements, wherein the plurality of external elements are electrically connected to the plurality of elastic elements.

5. The optical element driving mechanism as claimed in claim 4, wherein the plurality of elastic elements are electrically connected to the driving assembly.

6. The optical element driving mechanism as claimed in claim 4, wherein the fixed part further includes:
a frame;
a base, wherein the frame is fixedly connected to the base; and
a bottom, wherein the base is connected to the bottom via the plurality of elastic elements.

7. The optical element driving mechanism as claimed in claim 6, wherein the plurality of external elements are located on a first side of the bottom.

8. The optical element driving mechanism as claimed in claim 7, wherein the driving assembly includes:
a magnetic element, disposed on the movable part; and
a coil, disposed on a protruding structure of the base, adjacent to the first side.

9. The optical element driving mechanism as claimed in claim 8, wherein the protruding structure protrudes towards the first side.

10. The optical element driving mechanism as claimed in claim 8, wherein the movable part includes a stabilizing element, fixedly disposed on the side that is opposite the magnetic element.

11. The optical element driving mechanism as claimed in claim 8, further comprising a guiding assembly, including a plurality of guiding elements, disposed between the movable part and the frame, adjacent to the first side.

12. The optical element driving mechanism as claimed in claim 11, wherein the movable part is connected to the frame via the plurality of guiding elements.

13. The optical element driving mechanism as claimed in claim 11, wherein the distance between the plurality of guiding elements and an optical axis of incident light is greater than the distance between the magnetic element and the optical axis.

14. The optical element driving mechanism as claimed in claim 8, wherein the base includes:
a first part; and
a second part, fixedly connected to the first part.

15. The optical element driving mechanism as claimed in claim 14, wherein the thickness of the second part is greater than the thickness of the first part.

16. The optical element driving mechanism as claimed in claim 14, wherein the hardness of the second part is greater than the hardness of the first part.

17. The optical element driving mechanism as claimed in claim 8, wherein the base further includes a plurality of connecting elements, wherein the plurality of elastic elements are electrically connected to the coil via the plurality of connecting elements.

18. The optical element driving mechanism as claimed in claim 6, wherein the external element further includes a plurality of electrical connection parts extending in the direction of the incident light, wherein:
the distance between the electrical connection parts and an optical axis of the incident light is greater than the distance between the bottom and the optical axis; and
when viewed along the direction of the incident light, the electrical connection parts at least partially overlap the bottom.

19. The optical element driving mechanism as claimed in claim 8, wherein the magnetic element includes a first surface and a second surface, the first surface and the second surface are both curved surfaces, wherein:
the first surface and the second surface face opposite directions;
the second surface faces the coil; and
the radius of curvature of the first surface is different from the radius of curvature of the second surface.

20. The optical element driving mechanism as claimed in claim 19, wherein the radius of curvature of the first surface is smaller than the radius of curvature of the second surface.
